(19) United States
(12) Patent Application Publication
(10) Pub. No.: US 2021/0150476 A1
(43) Pub. Date: May 20, 2021

(54) WHERE-USED INFORMATION FOR USER INTERFACE

(71) Applicant: SAP SE, Walldorf (DE)

(72) Inventors: Stefan Resag, Walldorf (DE); Umesh K, Bangalore (IN); Hemant Mangal, Dholpur (IN)

(21) Appl. No.: 16/686,763

(22) Filed: Nov. 18, 2019

(51) Int. Cl. G06Q 10/10; G06Q 30/04; G06F 16/25; G06F 8/71; G06Q 10/06

(52) U.S. Cl. CPC G06Q 10/10; G06Q 30/04; G06Q 10/067; G06F 8/71; G06Q 10/06375; G06F 16/254

(57) ABSTRACT

A system includes receiving, via a first user interface, a selection of a user interface field related to a business object, retrieving, from a metadata repository, modeling content of the business object, generating a second user interface including the modeling content retrieved from the metadata repository, and identifying metadata of the business object that corresponds to the user interface field by directly assessing the modeling content via the second user interface.

### BACKGROUND

Users working with enterprise software systems often need to relate certain information visible on a user interface to other artifacts. For example, in order to acquire information to create additional software artifacts, such as to extend or add on to a software solution, a user must understand where to locate the relevant artifacts and entities. The manual process of identifying this where-used information for a user interface can be resource-intensive and error-prone. Missing information leads to lengthy software implementation processes.

### BRIEF DESCRIPTION OF THE DRAWINGS

FIG. 1 is a block diagram of a system according to some embodiments.

FIG. 2 is a flow diagram of a process according to some embodiments.

FIG. 3 is an outward view of a user interface for selecting a user interface field according to some embodiments.

FIG. 4 is an outward view of a user interface for obtaining where-used information according to some embodiments.

FIG. 5 is an outward view of a user interface for obtaining where-used information according to some embodiments.

FIG. 6 is a block diagram of a mobile device according to some embodiments.

### DETAILED DESCRIPTION

The following description is provided to enable any person in the art to make and use the described embodiments. Various modifications, however, will remain readily apparent to those in the art.

Briefly, according to some embodiments, a system leverages modeling/metadata content of a metadata repository to ease the identification of where-used information. Beginning from a UI field, corresponding metadata information is automatically generated on a where-used UI. Where-used information is made directly accessible by selecting a user interface field and navigating to the where-used information from there (e.g., forward navigation). Users and implementation partners can understand and adapt software accordingly.

Advantageously, the disclosed embodiments provide increased transparency of where to find related software artifacts and shortened implementation lead times.

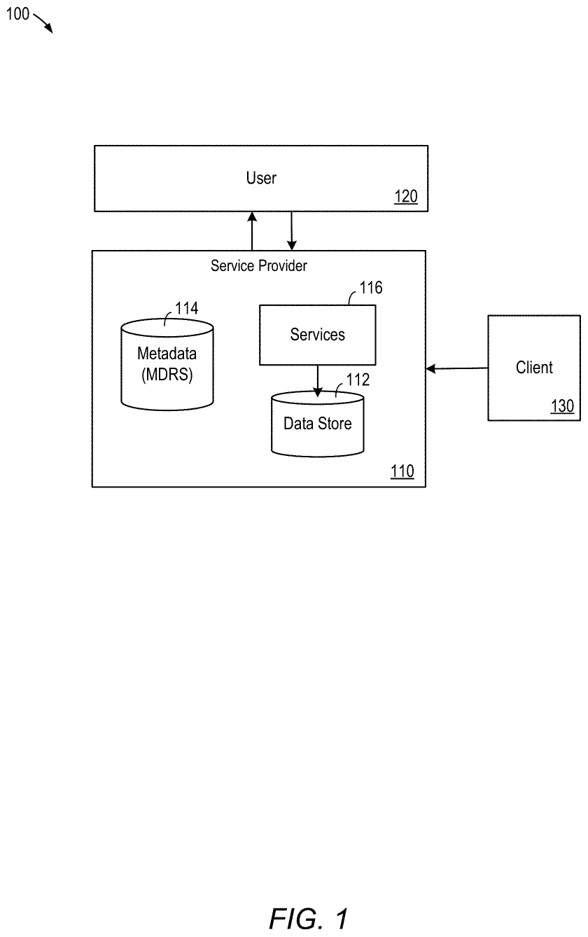

FIG. 1 is a block diagram of system 100 according to some embodiments.

System 100 includes service provider 110 for providing services to user 120 on behalf of client 130. For example, client 130 may represent an enterprise employing service provider 110 to facilitate processes (e.g., business processes), and user 120 may represent any entity requiring interaction with service provider 110 to further the processes of client 130.

Service provider 110 might receive requests from user 120 and provide responses to user 120 via a service-oriented architecture (SOA).

Service provider 110 might store client information into and retrieve client information from physical tables of data store 112. Data store 112 may comprise a relational database. Alternatively, data store 112 could be a multi-dimensional database, an eXtendable Markup Language (XML) document, or any other structured data storage system. The physical tables may be distributed among several relational databases, dimensional databases, and/or other data sources. To provide economies of scale, data store 112 may include data of more than one client. Service provider 110 includes mechanisms to ensure that a client/user accesses only the data that the client/user is authorized to access.

The structures of and relationships between the physical database tables may be complex, and business objects may be used to shield developers and end-users from these complexities. A business object may comprise, for example, a software model including nodes to encapsulate related data and methods. As described above, a business object may be associated with an entity, such as a client, partner, sales order, product, store, time, etc., represented in the data of a data source. Each instance of a business object may represent a particular instance of the entity represented by the business object. An instance of a SALES_ORDER business object may, for example, provide a mapping to the underlying tables storing data associated with a particular sales order. Business objects and data related to business objects can be stored in a storage mechanism, such as a database or any other persistent storage repository.

Metadata repository (MDRS) 114 may store metadata defining the logical entities (e.g., relational database tables and their respective interrelating schemas) of data store 112. Metadata repository 114 may also store metadata defining objects which are mapped to logical entities of data store 112. Metadata 114 provides information regarding the structure and attributes of the data of underlying business object instances (i.e., the data stored in data store 112). Metadata 114 may include design-time and/or runtime proxy objects generated based on other metadata (e.g., an eXtensible Markup Language (XML) representation of business object 115) stored therein.

MDRS may be stored in a physical location or may be a virtual database, in which metadata is drawn from separate sources. Metadata may include, for example, information about how to access specific data, or more detail about data.

Services 116 may use metadata 114 to access data of data store 112. Services 116 may provide user 120 with user interfaces, print forms, search capabilities, message interfaces, etc. based on data stored in data store 112 and defined by metadata 114.

User 120 may execute a Web browser to access services 116 via HyperText Transport Protocol (HTTP) communication. For example, a user may manipulate a user interface of user 120 to input an instruction (e.g., “show me a sales report”). User 120, in response, may transmit a corresponding HTTP service request to service provider 110. Services 116 may conduct any processing required by the request (e.g., generating views and user interfaces) and, after completing the processing, provide a response to user 120.

User 120 might comprise a Personal Computer (PC) or mobile device executing a Web client. Examples of a Web client include, but are not limited to, a Web browser, an execution engine (e.g., JAVA, Flash, Silverlight) to execute associated code in a Web browser, and/or a proprietary standalone application.

Client 130 may customize consuming business entities which are provided by service provider 110.

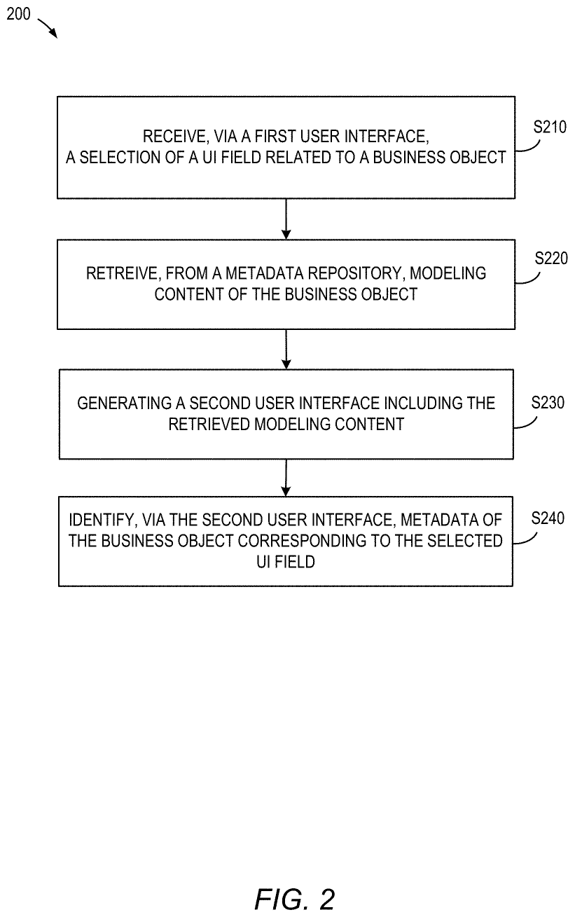

FIG. 2 is a flow diagram of process 200 according to some embodiments. More specifically, FIG. 2 is a flow diagram illustrating a process for providing modeling information for user-interface fields including where-used information. In some embodiments, various hardware elements of an application platform execute program code to perform process 200

Process 200 and all other processes mentioned herein may be embodied in computer-executable program code read from one or more of non-transitory computer-readable media, such as a floppy disk, a CD-ROM, a DVD-ROM, a Flash drive, and a magnetic tape, and then stored in a compressed, uncompiled and/or encrypted format. In some embodiments, hard-wired circuitry may be used in place of, or in combination with, program code for implementation of processes according to some embodiments. Embodiments are therefore not limited to any specific combination of hardware and software.

Initially, at S210, a selection of a user interface (UI) field related to a business object is received at a first user interface. At 220, modeling content of the business object is retrieved from a metadata repository. In turn, at S230, a second user interface is generated including the modeling content retrieved from the metadata repository.

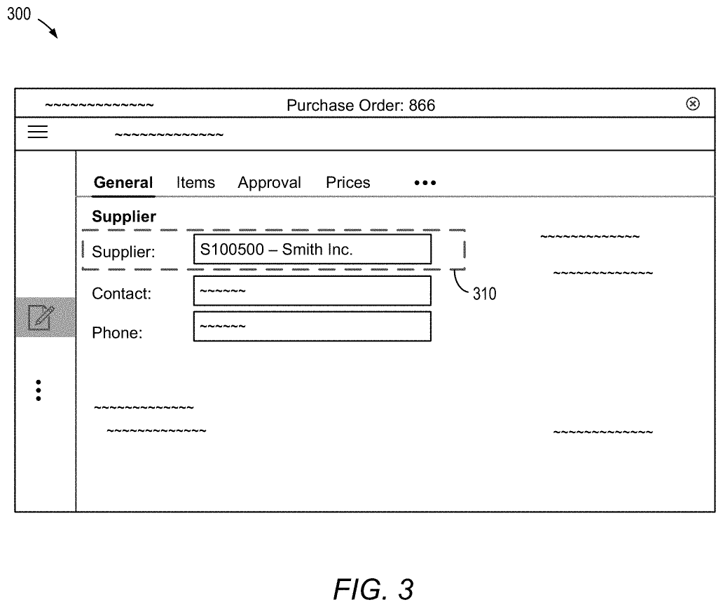

The modeling content of the business object is exposed to a user interacting with a user interface. Thereby, at 240, metadata of the business object that corresponds to the user interface field is identified by directly assessing the modeling content via the second user interface. In some embodiments, the modeling content (e.g., metadata) is defined (e.g., by a developer) during software development.

Where-used information is directly accessible by selecting a user interface field and navigating to the where-used information from there (e.g., forward navigation). By way of example, referring to FIG. 3, a user may interact with a user interface to select a user interface field 310 (e.g., “Supplier”) on a graphical user interface 300. Upon pressing an execute button (not shown), a user is presented with a second user interface 400 including public solution model (PSM) information 410 (e.g., modeling content). In some embodiments, the execute button is a forward navigation button such as an “F1” key. The PSM includes all entities in a cloud solution that are released for use by external customers. External customers can be partners who develop solutions on top of the cloud solution such as add-ons and integration scenarios or administrators, who, e.g., use data resources to create new reports.

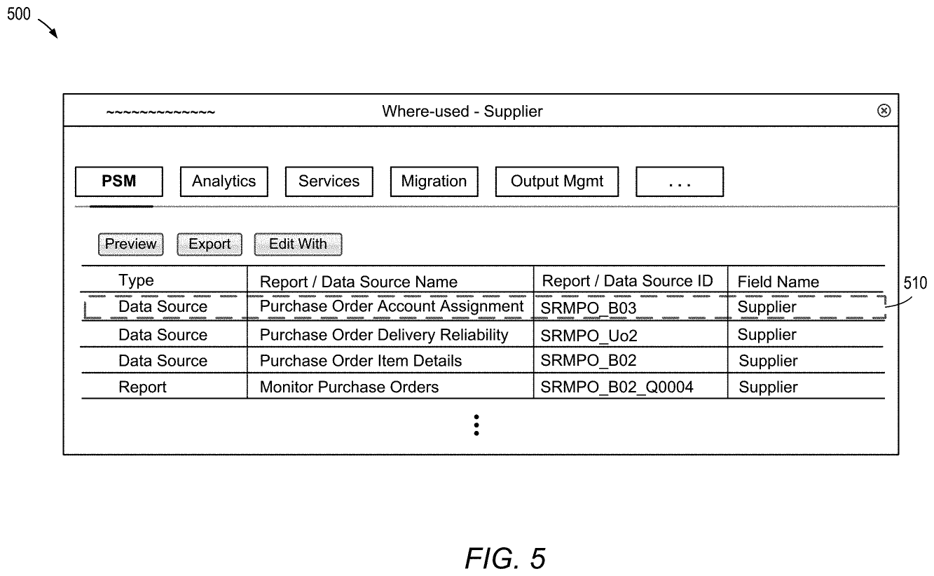

In another example, referring to FIG. 5, upon pressing an execute button (not shown), a user is presented with a second user interface 500 including a list of data sources where the user interface field (e.g., “Supplier”) may be found.

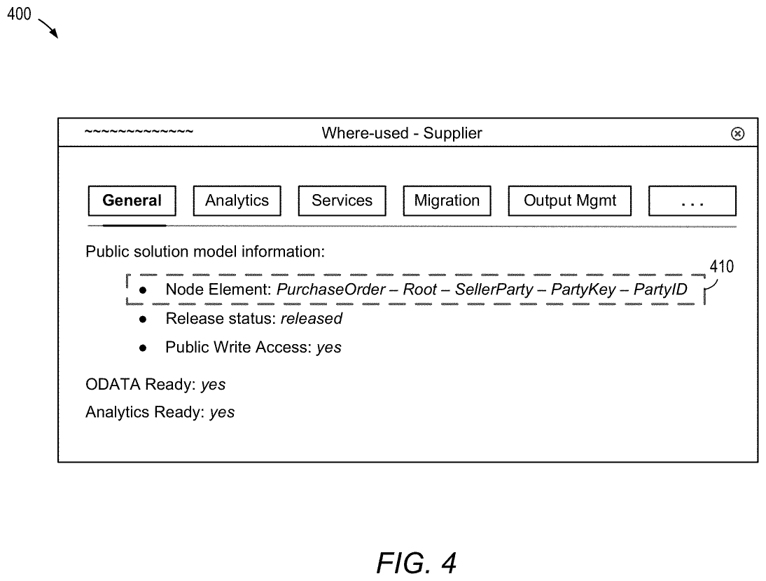

The modeling content (e.g., where-used information) includes a type of artifact where the UI field is present (e.g. SOAP/ODATA web service, data source, analytical report, print form, migration templates, other user interfaces), a name of the artifact (e.g. name of the web service or data source, such as “SRMPO_B03” 510 in FIG. 5), name of the field in the artifact that represents the UI field (e.g., on the UI the field could be named “Delivery address”, but in the web service the name could be “Product Recipient Address”; on the UI the field could be named “Supplier” 310 in FIG. 3, but in the business object artifact the name could be “Party ID” 410 in FIG. 4), and a link or more information on how to access the artifact (e.g., action buttons “Preview”, “Export”, or “Edit With” in FIG. 5).

Advantageously, users may navigate directly from a user interface field to the particular modeling content relating to the business object. Metadata is evaluated on-the-fly and exposed to the user of a user interface. A business object field is mapped to a user interface field using modeling content. Where-used information made available to the user may be used to identify available artifacts (e.g., web services or analytical data sources) that support the respective UI field.

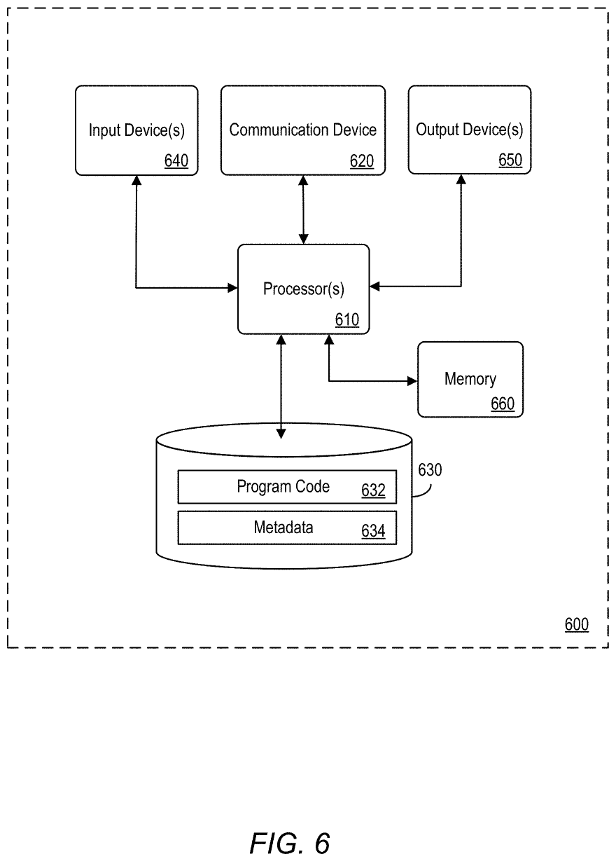

FIG. 6 is a block diagram of apparatus 600 according to some embodiments. Apparatus 600 may comprise a general-purpose computing apparatus and may execute program code to perform any of the functions described herein. Apparatus 600 may include other unshown elements according to some embodiments.

Apparatus 600 includes processor 610 operatively coupled to communication device 620, data storage device 630, one or more input devices 640, one or more output devices 650 and memory 660. Communication device 620 may facilitate communication with external devices, such as an external design tool. Input device(s) 640 may comprise, for example, a keyboard, a keypad, a mouse or other pointing device, a microphone, knob or a switch, an infra-red (IR) port, a docking station, and/or a touch screen. Input device(s) 640 may be used, for example, to enter information into apparatus 600. Output device(s) 650 may comprise, for example, a display (e.g., a display screen) a speaker, and/or a printer.

Data storage device 630 may comprise any appropriate persistent storage device, including combinations of magnetic storage devices (e.g., magnetic tape, hard disk drives and flash memory), optical storage devices, Read Only Memory (ROM) devices, etc., while memory 660 may comprise Random Access Memory (RAM). Data storage device 630 may comprise any appropriate persistent storage device, including combinations of magnetic storage devices (e.g., magnetic tape, hard disk drives and flash memory), optical storage devices, Read Only Memory (ROM) devices, etc., while memory 660 may comprise Random Access Memory (RAM).

Program code 632 may be executed by processor 610 to cause apparatus 600 to perform any one or more of the processes described herein. Embodiments are not limited to execution of these processes by a single apparatus. Metadata 634 may include metadata described herein with respect to metadata and/or MDRS 114. Data storage device 630 may also store data and other program code for providing additional functionality and/or which are necessary for operation thereof, such as device drivers, operating system files, etc.

Several of the foregoing diagrams represent logical architectures for describing processes according to some embodiments, and actual implementations may include more or different components arranged in other manners. Moreover, each system described herein may be implemented by any number of devices in communication via any number of other public and/or private networks. Two or more of devices of may be located remote from one another and may communicate with one another via any known manner of network(s) and/or a dedicated connection. Moreover, each device may comprise any number of hardware and/or software elements suitable to provide the functions described herein as well as any other functions. Other topologies may be used in conjunction with other embodiments.

All systems and processes discussed herein may be embodied in program code stored on one or more computer-readable media. Such media may include, for example, a floppy disk, a CD-ROM, a DVD-ROM, a Zip® disk, magnetic tape, and solid state Random Access Memory (RAM) or Read Only Memory (ROM) storage units. Embodiments are therefore not limited to any specific combination of hardware and software.

The embodiments described herein are solely for the purpose of illustration. Those in the art will recognize other embodiments may be practiced with modifications and alterations limited only by the claims.

1. A system comprising:
a processor; and
a memory in communication with the processor, the memory storing program instructions, the processor operative with the program instructions to perform the operations of:
receiving, via a first user interface, a selection of a user interface field related to a business object;
in response to the received selection, retrieving, from a metadata repository, modeling content of the business object, the modeling content comprising a type of a data source in which the user interface field is present, a name of the data source, and a name of a field in the data source that represents the user interface field;
in response to retrieving the modeling content, generating a second user interface including the modeling content retrieved from the metadata repository; and
identifying, via the second user interface, metadata of the business object that corresponds to the user interface field.

2. The system of claim 1, wherein the modeling content includes where-used information associated with the user interface field.

3. The system of claim 2, further comprising directly navigating to the where-used information from the first user interface.

4. The system of claim 1, further comprising identifying software artifacts that support the user interface field.

5. The system of claim 1, wherein the modeling content includes a type of an artifact, a name of an artifact, a name of a field in the artifact, and information on how to access the artifact.

6. The system of claim 1, wherein the second user interface is generated in response to a key input on the first user interface.

7. The system of claim 1, wherein the modeling content is defined during software development.

8. A computer-implemented method comprising:
receiving, via a first user interface, a selection of a user interface field related to a business object;
in response to the received selection, retrieving, from a metadata repository, metadata of the business object, the metadata comprising a type of a data source in which the user interface field is present, a name of the data source, and a name of a field in the data source that represents the user interface field;
in response to retrieving the metadata, directly navigating to a second user interface displaying the metadata of the business object; and
identifying metadata of the business object that corresponds to the user interface field.

9. The method of claim 8, wherein the metadata includes where-used information associated with the user interface field.

10. The method of claim 9, further comprising directly navigating to the where-used information from the first user interface.

11. The method of claim 8, further comprising identifying software artifacts that support the user interface field.

12. The method of claim 8, wherein the metadata includes a type of an artifact, a name of an artifact, a name of a field in the artifact, and information on how to access the artifact.

13. The method of claim 8, wherein the second user interface is generated in response to a key input on the first user interface.

14. The method of claim 8, wherein the metadata is defined during software development.

15. A non-transitory computer readable medium having stored therein instructions that when executed cause a computer to perform a method comprising:
receiving, via a first user interface, a selection of a user interface field related to a business object;
in response to the received selection, retrieving, from a metadata repository, modeling content of the business object, the modeling content comprising a type of a data source in which the user interface field is present, a name of the data source, and a name of a field in the data source that represents the user interface field;
in response to retrieving the modeling content, generating a second user interface including the modeling content retrieved from the metadata repository; and
identifying metadata of the business object that corresponds to the user interface field by directly assessing the modeling content via the second user interface.

16. The non-transitory computer-readable medium of claim 15, wherein the modeling content includes where-used information associated with the user interface field.

17. The non-transitory computer-readable medium of claim 16, further comprising directly navigating to the where-used information from the first user interface.

18. The non-transitory computer-readable medium of claim 15, further comprising identifying software artifacts that support the user interface field.

19. The non-transitory computer-readable medium of claim 15, wherein the modeling content includes a type of an artifact, a name of an artifact, a name of a field in the artifact, and information on how to access the artifact.

20. The non-transitory computer-readable medium of claim 15, wherein the second user interface is generated in response to a key input on the first user interface.
